(19) United States
(12) Patent Application Publication
(10) Pub. No.: US 2010/0208974 A1
(43) Pub. Date: Aug. 19, 2010

(54) Methods for Ranking Cellular Images

(76) Inventors: Jan Keij, Media, PA (US); John Silvia, Huntingdon Valley, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/439,698

(22) PCT Filed: Aug. 30, 2007
(86) PCT No.: PCT/US07/19045

§ 371 Date: Mar. 3, 2009

Related U.S. Application Data
(60) Provisional application No. 60/842,405, filed on Sep. 5, 2006.

(51) Int. Cl. G06K 9/00

(52) U.S. Cl. 382/133

(57) ABSTRACT

The methods described in this invention are used to analyze images of circulating tumor cells (CTC). Images are acquired from a number of platforms, including multiparameter flow cytometry, the CellSporter fluorescent microscopy imaging system and CellTracks Analyzer. These images are then ranked based on various properties and are presented to the user in order of most likely to least likely positive CTC events. The ranking method is useful to diagnose, monitor, and screen disease based on circulating rare cells, such as malignancy as determined by CTC.

### CROSS REFERENCE TO RELATED APPLICATIONS

This application is a non-provisional application, which is incorporated by reference herein and claims priority, in part, of U.S. Provisional Application No. 60/842,405, filed 5 Sep. 2006.

### FIELD OF THE INVENTION

This invention relates generally to image analysis. Images, such as circulating tumor cells, are obtained from flow cytometry or fluorescent microscopy and ranked by their physical properties.

### BACKGROUND OF THE INVENTION

Many clinicians believe that cancer is an organ-confined disease in its early stages. However, it appears that this notion is incorrect, and cancer is often a systemic disease by the time it is first detected using methods currently available. There is evidence that primary cancers begin shedding neoplastic cells into the circulation at an early disease stage prior to the appearance of clinical manifestations. Upon vascularization of a tumor, tumor cells shed into the circulation may attach and colonize at distant sites to form metastases. These circulating tumor cells (CTC) contain markers not normally found in healthy individuals' cells, thus forming the basis for diagnosis and treatment of specific carcinomas. Hence, the presence of tumor cells in the circulation can be used to screen for cancer in place of, or in conjunction with, other tests, such as mammography, or measurements of PSA. By employing appropriate mononclonal antibodies directed to associated markers on or target cells, or by using other assays for cell protein expression, or by the analysis of cellular mRNA, the organ origin of such cells may readily be determined, e.g., breast, prostate, colon, lung, ovarian or other non-hematopoietic cancers.

Thus, in cases where cancer cells can be detected, while there are essentially no clinical signs of a tumor, it will be possible to identify their presence as well as the organ of origin. Furthermore, based on clinical data, cancer should be thought of as a blood borne disease characterized by the presence of potentially very harmful metastatic cells, and therefore, treated accordingly. In cases where there is absolutely no detectable evidence of CTC, e.g., following surgery, it may be possible to determine from further clinical study whether follow-up treatment, such as radiation, hormone therapy or chemotherapy is required. Predicting the patient's need for such treatment, or the efficacy thereof, given the costs of such therapies, is a significant and beneficial piece of clinical information. It is also clear that the number of tumor cells in the circulation is related to the stage of progression of the disease, from its inception to the final phases of disease.

Malignant tumors are characterized by their ability to invade adjacent tissue. In general, tumors with a diameter of 1 mm are vascularized and animal studies show that as much as 4% of the cells present in the tumor can be shed into the circulation in a 24 hour period (Butler, T P & Gullino P M, 1975 Cancer Research 35:512-516). The shedding capacity of a tumor is most likely dependent on the aggressiveness of the tumor. Although tumor cells are shed into the circulation on a continuous basis, it is believed that none or only a small fraction will give rise to distant metastasis (Butler & Gullino, supra). Increase in tumor mass might be expected to be proportional to an increase in the frequency of the circulating tumor cells. If this were found to be the case, methods available with a high level of sensitivity would facilitate assessment of tumor load in patients with distant metastasis as well as those with localized disease. Detection of tumor cells in peripheral blood of patients with localized disease has the potential not only to detect a tumor at an earlier stage but also to provide indications as to the potential invasiveness of the tumor.

Detection of circulating tumor cells by microscopic imaging is similarly adversely affected by spurious decreases in classifiable tumor cells and a corresponding increase in interfering stainable debris. Hence, maintaining the integrity or the quality of the blood specimen is of utmost importance, since there may be a delay of as much as 24 hours between blood draw and specimen processing. Such delays are to be expected, since the techniques and equipment used in processing blood for this assay may not be readily available in every laboratory. The time necessary for a sample to arrive at a laboratory for sample processing may vary considerably. It is therefore important to establish the time window within which a sample can be processed. In routine hematology analyses, blood samples can be analyzed within 24 hours. However, as the analysis of rare blood cells is more critical, the time window in which a blood sample can be analyzed is shorter.

An example is immunophenotyping of blood cells, which, in general, must be performed within 24 hours. In a cancer cell assay, larger volumes of blood have to be processed, and degradation of the blood sample can become more problematic as materials released by disintegrating cells, both from CTC and from hematopoietic cells, can increase the background and therefore decrease the ability to detect tumor cells. Large numbers of CTC can be continuously shed from a tumor site, and a steady-state level is maintained in which destruction of CTC equals the shedding rate which in turn depends on the size of the tumor burden (see J G Moreno et al. “Changes in Circulating Carcinoma Cells in Patients with Metastatic Prostate Cancer Correlates with Disease State.” Urology 58. 2001).

Generally, the more resistant and proliferative cells survive to establish secondary or metastatic sites. In the peripheral circulation, CTC are further attacked in vivo (and also in vitro) by activated neutrophils and macrophages resulting progressively in membrane perforation, leakage of electrolytes, smaller molecules, and eventual loss of critical cellular elements including DNA, chromatin, etc, which are essential for cell viability. At a critical point of the cell's demise, cell destruction is further assisted by apoptosis. Apoptosis is characterized by a series of stepwise slow intracellular events, which differs from necrosis or rapid cell death triggered or mediated by an extracellular species, e.g. a cytotoxic anti-tumor drug. All or some of these destructive processes may lead to formation of debris and/or aggregates including stainable DNA, DNA fragments and “DNA ladder” structures from disintegrating CTC as well as from inadvertent destruction of normal hematopoietic cells during drug therapy, since most cytotoxic drugs are administered at near toxic doses.

Various methods are known in this particular art field for recovering tumor cells from blood. For example, U.S. Pat. No. 6,190,870 to AmCell and Miltenyi teaches immunomagnetic isolation followed by flow cytometric enumeration. However, before immunomagnetic separation, the blood samples are pre-processed using density gradients. There is also no visual analysis of the samples.

In U.S. Pat. No. 6,365,362 to Immunivest, methods are described for immunomagnetically enriching and analyzing samples for tumor cells in blood. The methods are specifically directed towards analyzing intact cells, where the number of cells correlates with the disease state. The isolated cells are labeled for the presence of nucleic acid and an additional marker, which allows the exclusion of non-target sample components during analysis.

Epithelial cells in their tissue of origin obey established growth and development “rules”. Those rules include population control. This means that under normal circumstances the number and size of the cells remains constant and changes only when necessary for normal growth and development of the organism. Only the basal cells of the epithelium or immortal cells will divide and they will do so when it is necessary for the epithelium to perform its function, whatever it is depending in the nature and location of the epithelium. Under some abnormal but benign circumstances, cells will proliferate and the basal layer will divide more than usual, causing hyperplasia. Under some other abnormal but benign circumstances, cells may increase in size beyond what is normal for the particular tissue, causing cell gigantism, as in folic acid deficiency.

Epithelial tissue may increase in size or number of cells also due to pre-malignant or malignant lesions. In these cases, changes similar to those described above are accompanied by nuclear abnormalities ranging from mild in low-grade intraepithelial lesions to severe in malignancies. It is believed that changes in these cells may affect portions of the thickness of the epithelium and as they increase in severity will comprise a thicker portion of such epithelium. These cells do not obey restrictions of contact inhibition and continue growing without tissue controls. When the entire thickness of the epithelium is affected by malignant changes, the condition is recognized as a carcinoma in situ (CIS).

The malignant cells eventually are able to pass through the basement membrane and invade the stroma of the organ as their malignant potential increases. After invading the stroma, these cells are believed to have the potential for reaching the blood vessels. Once they infiltrate the blood vessels, the malignant cells find themselves in a completely different environment from the one they originated from.

The cells may infiltrate the blood vessels as single cells or as clumps of two or more cells. A single cell of epithelial origin circulating through the circulatory system is destined to have one of two outcomes. It may die or it may survive.

### BRIEF DESCRIPTION OF THE INVENTION

The methods described in this invention are used to analyze images of circulating tumor cells (CTC). Images may be acquired from a number of platforms, including multiparameter flow cytometry, the CellSpotter fluorescent microscopy imaging system and CellTracks Analyzer. These images are then ranked based on various properties and are presented to the user in order of most likely to least likely positive CTC events. Herein are described methods to diagnose, monitor, and screen disease based on circulating rare cells, including malignancy as determined by CTC.

### DESCRIPTION OF FIGURES

FIG. 1 shows images of a positive CTC event.

FIG. 2 shows images of a positive CTC event with a leukocyte in the same frame.

FIG. 3 shows images of a positive CTC event with multiple leukocytes in the same frame.

### DETAILED DESCRIPTION OF THE INVENTION

Herein, various terms that are well understood by those of ordinary skill in the art are used. The intended meaning of these terms does not depart from the accepted meaning.

The terms “biological specimen” or “biological sample” may be used interchangeably, and refer to a small potion of fluid or tissue taken from a human subject that is suspected to contain cells of interest, and is to be analyzed. A biological specimen refers to the fluidic portion, the cellular portion, and the portion containing soluble material. Biological specimens or biological samples include, without limit bodily fluids, such as peripheral blood, tissue homogenates, nipple aspirates, colonic lavage, sputum, bronchial lavage, and any other source of cells that is obtainable from a human subject. An exemplary tissue homogenate may be obtained from the sentinel node in a breast cancer patient.

The term “rare cells” is defined herein as cells that are not normally present in biological specimens, but may be present as an indicator of an abnormal condition, such as infectious disease, chronic disease, injury, or pregnancy. Rare cells also refer to cells that may be normally present in biological specimens, but are present with a frequency several orders of magnitude less than cells typically present in a normal biological specimen.

The term “determinant”, when used in reference to any of the foregoing target bioentities, refers broadly to chemical mosaics present on macromolecular antigens that often induce an immune response. Determinants may also be used interchangeably with “epitopes”. A “biospecific ligand” or a “biospecific reagent,” used interchangeably herein, may specifically bind determinants. A determinant refers to that portion of the target bioentity involved in, and responsible for, selective binding to a specific binding substance (such as a ligand or reagent), the presence of which is required for selective binding to occur. In fundamental terms, determinants are molecular contact regions on target bioentities that are recognized by agents, ligands and/or reagents having binding affinity therefore, in specific binding pair reactions.

The term “specific binding pair” as used herein includes antigen-antibody, receptor-hormone, receptor-ligand, agonist-antagonist, lectin-carbohydrate, nucleic acid (RNA or DNA) hybridizing sequences, Fc receptor or mouse IgG-protein A, avidin-biotin, streptavidin-biotin and virus-receptor interactions.

The term “detectably label” is used herein to refer to any substance whose detection or measurement, either directly or indirectly, by physical or chemical means, is indicative of the presence of the target bioentity in the test sample. Representative examples of useful detectable labels, include, but are not limited to the following: molecules or ions detectable based on light absorbance, fluorescence, reflectance, light scatter, phosphorescence, or luminescence properties; molecules or ions detectable by their radioactive properties; molecules or ions detectable by their nuclear magnetic resonance or paramagnetic properties. Included among the group of molecules indirectly detectable based on light absorbance or fluorescence, for example, are various enzymes which cause appropriate substrates to convert (e.g. from non-light absorbing to light absorbing molecules, or form non-fluorescent to fluorescent molecules). Analysis can be performed using any of a number of commonly used platforms, including multiparameter flow cytometry immunofluorescent microscopy, laser scanning cytometry, bright field base image analysis, capillary volumetry, spectral imaging analysis, manual cell analysis, CellSpotter analysis, CellTrack analysis, and automated cell analysis.

The phrase “to the substantial exclusion of” referes to the specificity of the binding reaction between the biospecific ligand or biospecific reagent and its corresponding target determinant. Biospecific ligands and reagents have specific binding activity for their target determinant yet may also exhibit a low level of non-specific binding to other sample components.

The phrase “early stage cancer” is used interchangeably herein with “Stage I” or “Stage II” cancer and refers to those cancers that have been clinically determined to be organ-confined. Also included are tumors too small to be detected by conventional methods such as mammography for breast cancer patients, or X-rays for lung cancer patients. While mammography can detect tumors having approximately 2×10⁸ cells, the methods of the present invention should enable detection of circulating cancer cells from tumors approximating this size or smaller.

The term “morphological analysis” as used herein, refers to visually observable characteristics for an object, such as size, shape, or the presence/absence of certain features. In order to visualize morphological features, an object is typically non-specifically stained. The term “epitopical analysis” as used herein, refers to observations made on objects that have been labeled for certain epitopes. In order to visualize epitopic features, an object is typically specifically stained or labeled. Morphological analysis may be combined with epitopical analysis to provide a more complete analysis of an object.

When a sample is analyzed, there may be a large number of images to review in order to make an assessment of the sample with certainty. Currently, a reviewer is presented images of all events. The order of these events is simply determined by their location in the sample chamber, i.e. the first images are at the beginning of the acquisition, and the last images are from the end of the acquisition. Each image must be reviewed independently of the others in order to make a confident determination. Because the events of interest are rare target cells, their location will occur randomly within a sample chamber, and subsequently randomly within the review. Therefore, identifying all of the infrequent events of interest may require reviewing the entire sample.

In making a diagnosis, the total number of positive events is the most important result. In disease such as cancer, the greater number of positive events determines the severity of the disease. In cases where there is an established threshold for the number of positive events, the actual number may not be as important as determining whether the sample exceeds this threshold or not. In other words, if a sample has many positive events and exceeds the threshold, the sample is can be considered positive without reviewing every individual event.

This invention will aid the reviewer by presenting the results in order of most likely to least likely meeting the established criteria for identifying a particular event. As the more certain candidates are presented at the beginning of the review, the review can more quickly make a determination if the sample exceeds a threshold. Furthermore, using this method, there will be a score where events above the score are mostly likely positive events, and those below are not.

To analyze an image, a reviewer uses criteria such as size, shape, and intensity of the object in the image. To determine whether the event is positive, the reviewer uses criteria such as the comparable size of the objects and amount of overlap of the images for a given event. In the case of identifying CTCs, the cell should be round or oval. The nucleus image should be smaller than the cytoplasm image. The nucleus should also be visibly surrounded the cytoplasm. The intensities of the images are also important in making the determination.

The present invention ranks CTC events based on a simple set of criteria. First it identifies cytokeratin positive events. Then for a given cytokeratin event, it measures the amount of overlap with the nucleic acid event. If these images suitably overlap, it determines whether the event is positive or negative as a leukocyte. As each event is passed through this set of criteria, the most likely CTC candidate events end up with higher scores, and during analysis, the reviewer is presented with the images based on their ranking scores.

### EXAMPLE 1

### CellTracks Analyzer Image Ranking

Samples that are analyzed with the CellTracks Analyzer are stained with cytokeratin-PE, DAPI, and CD45-APC. For CTC samples, the phycoerythrin (PE) positive, 4′,6-Diamidino-2-phenylindol (DAPI) positive, allophycocyanin (APC) negative events that also meet criteria for cells are counted as tumor cells. PE negative, APC positive events are counted as leukocytes. However, there are instances of PE positive, APC positive events. These are counted as dual-positive events.

For cytokeratin-PE images, the present invention analyzes staining intensity contours. The intensity of the objects that appear in these images can be noisy. Cytokeratin staining is rarely uniform in distinctly positive cells. In cases of typical cells, there is an amount of noise present in the images. The noise is removed using kuan filtering in the present invention. This is needed to find objects that are not uniformly bright as compared to background. The filtering also results in allowing the system to identify individual objects that are close together by finding the borders of each object.

DAPI is used to label nucleic acid. DAPI images are analyzed and are isolated into segments based on intensity profiles. Thresholds are set to prevent cases of over-segmenting, where a single object is represented as more than one separate segment. However, because nucleic acid staining is more predictable than cytokeratin staining, there is less filtering required to distinguish separate objects.

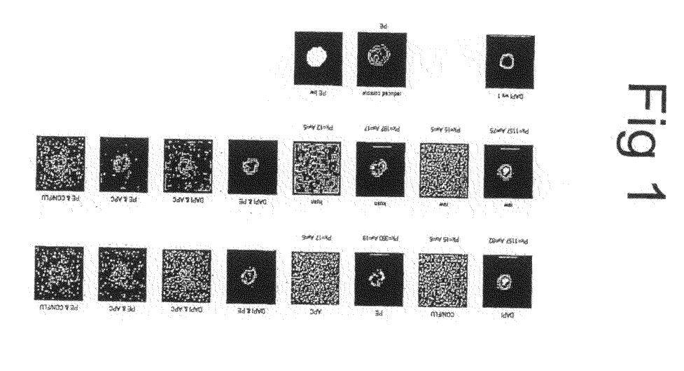

Once these objects are identified, they are scored based on their intensities for both cytokeratin-PE and DAPI. Objects with higher intensities are given higher scores. Then the object is analyzed based on the overlap of the two images. The nucleic acid should appear within the boundary of the cytokeratin. Objects with a higher fractional overlap are given higher scores. As seen in FIG. 1, the DAPI object fits well within the cytokeratin, and is a positive CTC event.

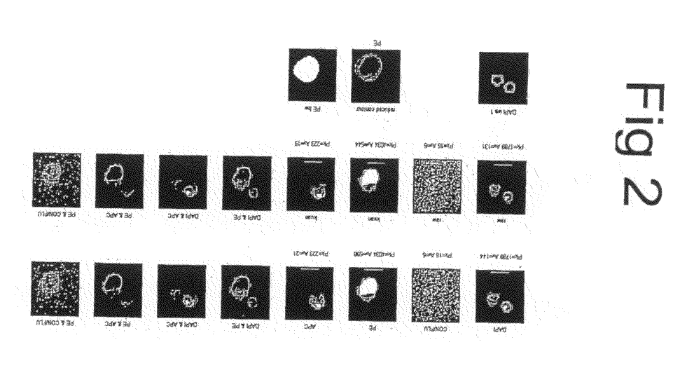

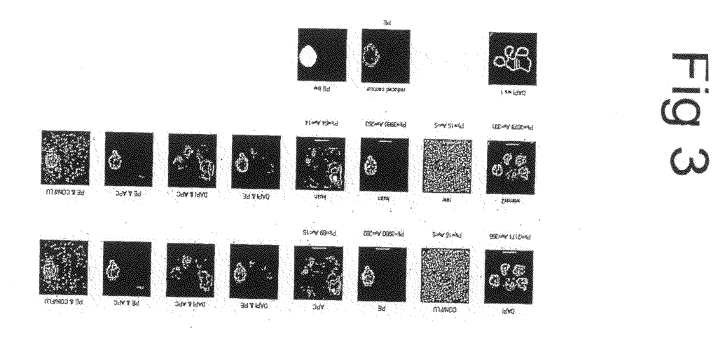

The sample is also stained with CD45-APC. This is used to stain leukocytes and identify non-target events. Objects that are positive for APC would not be considered CTC's. However, there is a small population of events that are positive for PE and APC, known as dual positive events. Therefore, instead of simply using APC positive or negative as a criteria, the ratio of APC and PE is used to separate dual-positive events from CTC's and leukocytes. These events are scored based on this ratio so that likely CTC's are given a higher score than likely leukocytes. In FIG. 2 and FIG. 3, the CTC (DAPI positive and PE positive) can be seen with leukocytes (APC positive and DAPI positive).

Once each object is analyzed through the above process, the images are presented to the reviewer in order of their scores. The result is that the events that are most likely CTC's appear at the beginning of the set of images, with the less likely objects appearing farther into the set.

Examples of different types of cancer that may be detected using the compositions, methods and kits of the present invention include apudoma, choristoma, branchioma, malignant carcinoid syndrome, carcinoid heart disease, carcinoma e.g., Walker, basal cell, basosquamous, Brown-Pearce, ductal, Ehrlich tumor, in situ, Krebs 2, merkel cell, mucinous, non-small cell lung, oat cell, papillary, scirrhous, bronchiolar, bronchogenic, squamous cell and transitional cell reticuloendotheliosis, melanoma, chondroblastoma, chondroma, chondrosarcoma, fibroma, fibrosarcoma, giant cell tumors, histiocytoma, lipoma, liposarcoma, mesothelioma, myxoma, myxosarcoma, osteoma, osteosarcoma, Ewing's sarcoma, synovioma, adenofibroma, adenolymphoma, carcinosarcoma, chordoma, mesenchymoma, mesonephroma, myosarcoma, ameloblastoma, cementoma, odontoma, teratoma, throphoblastic tumor, adenocarcinoma, adenoma, cholangioma, cholesteatoma, cylindroma, cystadenocarcinoma, cystadenoma, granulosa cell tumor, gynandroblastoma, hepatoma, hidradenoma, islet cell tumor, leydig cell tumor, papilloma, sertoli cell tumor, theca cell tumor, leiomyoma, leiomyosarcoma, myoblastoma, myoma, myosarcoma, rhabdomyoma, rhabdomyosarcoma, ependymoma, ganglioneuroma, glioma, medulloblastoma, meningioma, neurilemmoma, neuroblastoma, neuroepithelioma, neurofibroma, neuroma, paraganglioma, paraganglioma nonchromaffin, antiokeratoma, angioma sclerosing, angiomatosis, glomangioma, hemangioendothelioma, hemangioma, hemangiopericytoma, hemangiosarcoma, lymphangioma, lymphangiomyoma, lymphangiosarcoma, pinealoma, carcinosarcoma, chondrosarcoma, cystosarcoma phyllodes, fibrosarcoma, hemangiosarcoma, leiomyosarcoma, leukosarcoma, liposarcoma, lymphangiosarcoma, myosarcoma, myxosarcoma, ovarian carcinoma, rhabdomyosarcoma, sarcoma (Kaposi's, and mast-cell), neoplasms (e.g., bone, digestive system, colorectal, liver, pancreatic, pituitary, testicular, orbital, head and neck, central nervous system, acoustic, pelvic, respiratory tract, and urogenital), neurofibromatosis, and cervical dysplasia.

However, the present invention is not limited to the detection of circulating epithelial cells only. For example, endothelial cells have been observed in the blood of patients having a myocardial infarction. Endothelial cells, myocardial cells, and virally infected cells, like epithelial cells, have cell type specific determinants recognized by available monoclonal antibodies. Accordingly, the methods of the invention may be adapted to detect such circulating endothelial cells. Additionally, the invention allows for the detection of bacterial cell load in the peripheral blood of patients with infectious disease, who may also be assessed using the compositions, methods and kits of the invention. It would be reasonable to expect that these rare cells will behave similarly in circulation if present in similar conditions as those described hereinabove.

The preferred embodiments of the invention as herein disclosed, are also believed to enable the invention to be employed in fields and applications additional to cancer diagnosis. It will be apparent to those skilled in the art that the improved diagnostic modes of the invention are not to be limited by the foregoing descriptions of preferred embodiments. Finally, while certain embodiments presented above provide detailed descriptions, the following claims are not limited in scope by the detailed descriptions. Indeed, various modifications may be made thereto without departing from the spirit of the following claims.

We claim:

1. A method for ranking a cell image in a fluid sample comprising:
a. acquiring an image from a platform;
b. ranking said image properties from a group consisting of morphologic analysis, epitopical analysis and combinations thereof;
c. presenting images in order of most likely to least likely positive circulating tumor cell; and
d. selecting said images for analysis wherein said analysis is from a group consisting of diagnosing disease, monitoring disease, screening disease, and combinations thereof.

2. The method of claim 1 wherein said platform is multiparameter flow cytometry, CellSpoter fluorescent microscopy, or CellTracks Analyzer imaging.

3. The method of claim 1 wherein said morphologic analysis is from a group consisting of mensuration, shape analysis, size analysis, cytoplasm/nucleus overlap, cytoplasm/nucleus relative intensities, and combinations thereof.

4. The method of claim 1 wherein said epitopcial analysis is identifying a PE positive event, a DAPI positive event, and an APC negative event.

5. The method of claim 4 wherein background noise is removed by kuan filtering

6. The method of claim 1 wherein said cell image is from a group consisting of a circulating tumor cell, an epithelial cell, an endothelial cell, a bacterial cell, and a virally infected cell.

7. The method of claim 6 wherein said cell image is a circulating tumor cell.

8. The method of claim 7 wherein said epitopical analysis is identifying cytokeratin-PE positive event, DAPI-stained nucleus positive event, and CD-45 APC negative event.

9. The method of claim 8 wherein said order is by intensity scoring for said cytokeratin-PE positive event and said DAPI-stained nucleus positive event.

10. The method of claim 9 wherein said epitopical analysis is further determined by fractional overlap of said cytokeratin-PE positive event and said DAPI-stained nucleus positive event.

11. The method of claim 10 wherein CD-45 APC positive events are further scored by an APC to PE intensity ratio wherein a higher said intensity ration indicates a lower circulating tumor cell score.
